(19) United States
(12) Patent Application Publication
(10) Pub. No.: US 2007/0272749 A1
(43) Pub. Date: Nov. 29, 2007

(54) SYSTEM AND METHOD FOR INCREASING VOTER PARTICIPATION

(76) Inventors: Jordan Gehrke, Washington, DC (US); Michael Centanni, Washington, DC (US); Kimberly Bellissimo, Washington, DC (US)

Correspondence Address: Thomas Moga;Butzel Long, STONERIDGE WEST, 41000 WOODWARD AVENUE, BLOOMFIELD HILLS, MI, 48304, US

(21) Appl. No.: 11/752,651

(22) Filed: May 23, 2007

Related U.S. Application Data
(60) Provisional application No. 60/747,947, filed on May 23, 2006.

(51) Int. Cl. G07C 13/00

(52) U.S. Cl. 235/386; 705/12

(57) ABSTRACT

A system and method for increasing voter participation during election day. A poll worker uses an Internet enabled portable device to record when a registered voter votes and transmits that information to a central database in real time. Campaign headquarters view and manipulate real time voting data submitted by poll workers to create targeted phone and walk lists and various other reports for use during election day to increase the number of votes and after the election for statistical analysis.

### BACKGROUND OF THE INVENTION

The present invention relates to voting, and more particularly, to a system of tracking voters and non-voters during the course of an election day in order to increase registered voter participation.

Currently, campaigns use many different strategies to increase voter participation. These strategies may be based on historical data, party trends, and the personal expertise of the campaign manager. Collecting the using voter data can be invaluable during the various stages of the campaign. Unfortunately, such information is often voluminous and while time is available to process and use it during the campaign process, it is almost impossible to use effectively on election day when time is of the essence. Developing a system to organize and use voter data can be time consuming and expensive. In most cases, campaigns have limited funds and a limited workforce comprised mainly of volunteers. So instead of taking the time and spending the money to develop a voter information system, campaigns resort back to the “old” and known strategies. As a result, campaigns are finding it difficult to streamline the process and specifically target voters that have not yet voted during the election day.

Leading up to the election day, all registered and even unregistered voters may be the target for campaign reminders such as political endorsement signs, campaign phone calls, and door-to-door visits. On election day, though, blanket calling and door-to-door visits waste valuable time and manpower when calls or visits are made to people who have already voted or have no interest in the candidate or the ballot issue. Studies have shown that phone calls typically have a thirty percent success rate while the success rate for door-to-door visits ranges from twenty to eighty percent. Alternatively, personal contact by the candidate often results in a success rate as high as seventy percent. Therefore, efficiency of use of time on election day would increase and more votes would be placed if a campaign were able to focus its energies on the correct voters.

Accordingly, there is a need for a data management tool that provides a campaign with near real-time data, including identifying voters that have not yet voted so as to maximize the efficiency of the campaign workforce both during the days leading up to an election and especially on election day.

### SUMMARY OF THE INVENTION

The present invention concerns a system and method for increasing voter participation during election day, instead of having a paper list, the present invention provides access to an electronic voter list from an Internet enabled portable device such as a laptop computer, a PDA or a cell phone. Whenever a voter on the list comes into a polling place, that person's voting status is updated in the list on the portable device and transmitted to a central database in real time. In accordance with the present invention, a team at campaign headquarters can monitor voting trends in real time and use the real time data to focus campaign efforts.

### DESCRIPTION OF THE DRAWINGS

The above, as well as other advantages of the present invention will become readily apparent to those skilled in the art from the following detailed description of a preferred embodiment when considered in the light of the accompanying drawings in which:

FIG. 1 is a diagram of a system in accordance with the present invention;

FIG. 2 is block diagram of a system in accordance with the present invention;

FIG. 3 is a flow diagram of a system and method in accordance with the present invention;

FIG. 4 is a flow diagram of a portion of the method in accordance with the present invention;

FIGS. 5-14 are sample screen shots of a software application in accordance with the present invention;

### DESCRIPTION OF THE PREFERRED EMBODIMENT

The present invention concerns a web-based application (“Application”) that will be used on election days to record voters casting ballots at polling stations. This data will be used in real-time or near real-time by campaigns and possibly other groups and/or entities to deploy volunteers in low turn out areas to get out the vote. The data can also be used to analyze trends through graphing and mapping functionality and allow users to create call lists and walk lists to call or visit those registered voters who have not yet voted.

The overall features of the Application include, but are not limited to: (1) real time data tracking on election day, including graphical, numerical, and mapping analysis; (2) search functions to search for specific voters from a preloaded data file and the ability to record ballots being cast; (3) importation of voter files both manually and automatically; (4) the ability to create races and assign each race to a designated list of counties and districts; (5) management of users and assignment of users to group-based permissions with the ability to isolate at a precinct, city, county, and/or district level; (6) adaptability for local, state, and federal races; (7) create phone and walk lists based on real time election data and the ability to export the lists to users in the field; and (8) ability to view logs of system data including, but not limited to, voter activity.

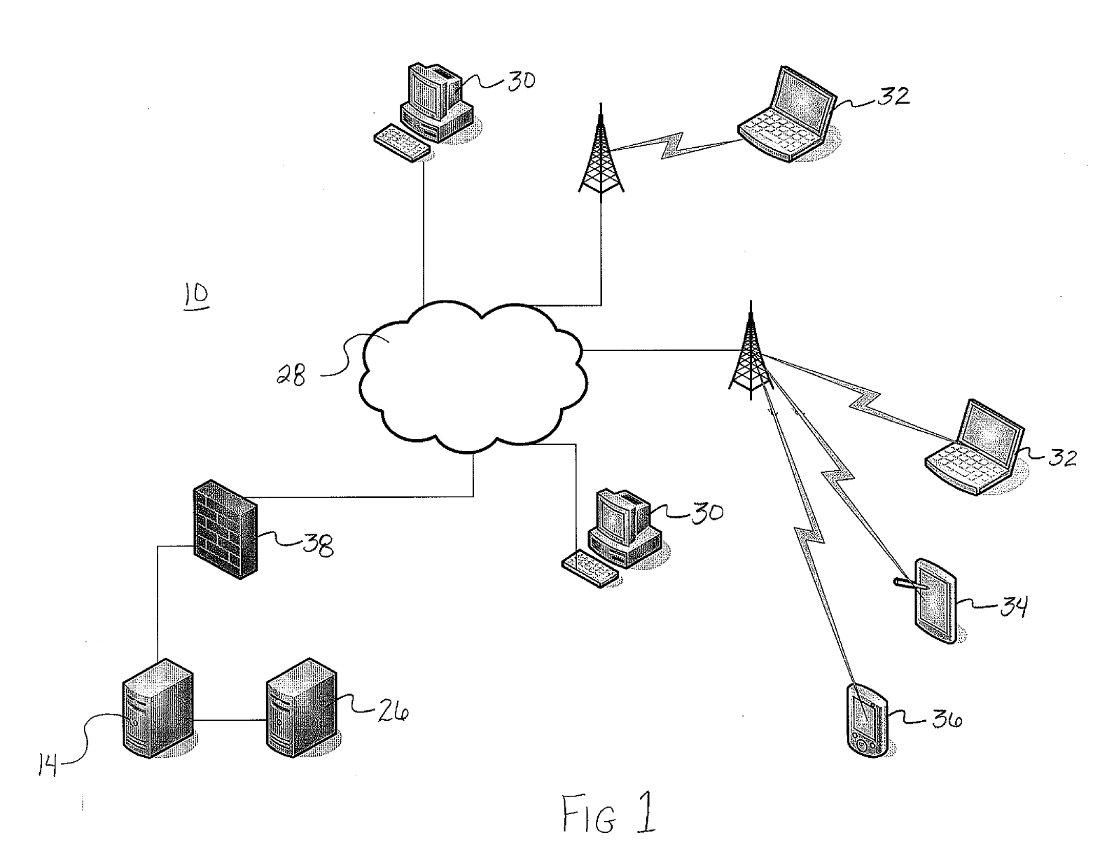

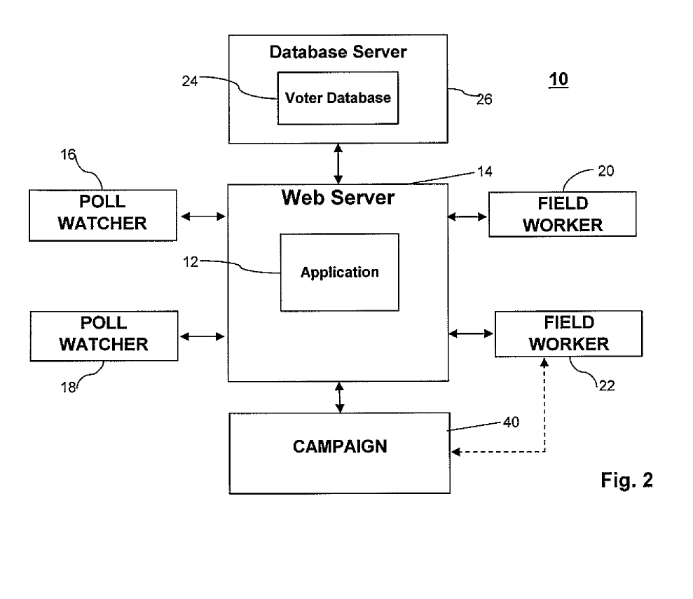

More specifically, referring to FIGS. 1 and 2, the system 10 of the present invention is a web-based Application 12 that resides on a web server 14 and allows users 16, 18, 20, 22 to connect to a voter database 24 residing on a database server 26 via an internet connection 28 from an internet-enabled computing device such as a personal computer 30, laptop 32, personal digital assistant 34, or any other smart-phone 36 or internet capable device. The internet connection 16 can be a wired connection or a wireless connection. The servers 14, 26 are preferably protected by a firewall 38.

The voter database 24 may contain many different types of information, but most importantly contains voter information including name, address, telephone number, party affiliation, state, county, district, and precinct information, and voting status. One will realize that more or less information may be contained in the database without varying from the scope of this invention. The information stored in the database for users will be described hereinbelow.

A campaign headquarters 40 connects to the central control to monitor one or more races on election day. Poll watchers 16 and 18 associated with the campaign headquarters 40 connect to the Application 12 to receive lists of registered voters associated with the polling places to be monitored by the poll watchers. As each registered voter votes, the poll watcher transmits that information via the Application 12 for entry into the database 24. The Application 12 then generates a report to the campaign 40. The campaign 40 uses the reports to instruct field workers 20 and 22 to contact registered voters who have not yet voted. The field workers 20 and 22 can report contact made with voters to the campaign 40 for entry into the database 24. The field workers 20, 22 can communicate with the campaign 40 through the Application 12, as shown, or directly (dashed line). Although two each of the poll watchers 16, 18 and field workers 20, 22, one database 24 and one campaign 40 are shown, the numbers are limited only by the data transmission and processing capabilities of the hardware and software utilized in the system 10. In fact, it is anticipated that multiple campaigns will use the Application 12 and multiple voter databases will reside on the database server 26.

The preferred embodiment of the present invention involves a central web server 14 and database server 26 that is used by numerous campaigns 40 versus each campaign 40 operating its 5 own servers 14, 26 that are maintained by and only accessible by that particular campaign 40. The benefit of the system of the current invention is that based on user security levels (described in more detail below), the campaign of a national candidate can use the real time voting data collected by the campaign for a local candidate of the same party in order to focus election day efforts. If each campaign operated its own voter tracking system, such efforts would not be as easily coordinated and would require more manpower since the national candidate and the local candidate would each need to have a poll worker present at the same polling site.

As an example, say that United States President candidate A of party X is running against candidate B of party Y. Also, on the same election day, candidate C of party X is running for United States Senate and candidate D, also of party X, is running for state representative. If all the candidates are using voting tracking systems operated on their own servers, then each candidate would have to have poll workers in each of the districts, cities, counties, states, etc in which voters were able to vote for him. However, with the present invention, the real time voting data recorded by candidate D's poll workers could be made accessible by candidate A's campaign and candidate C's campaign since they are all in the same party. This results in the need for less poll workers and the ability for campaigns to use more volunteers/workers in the field on election day. Notably, while candidate A and candidate B may maintain and use the same list of voters, the database for each would be separate and inaccessible by the other since they are opponents.

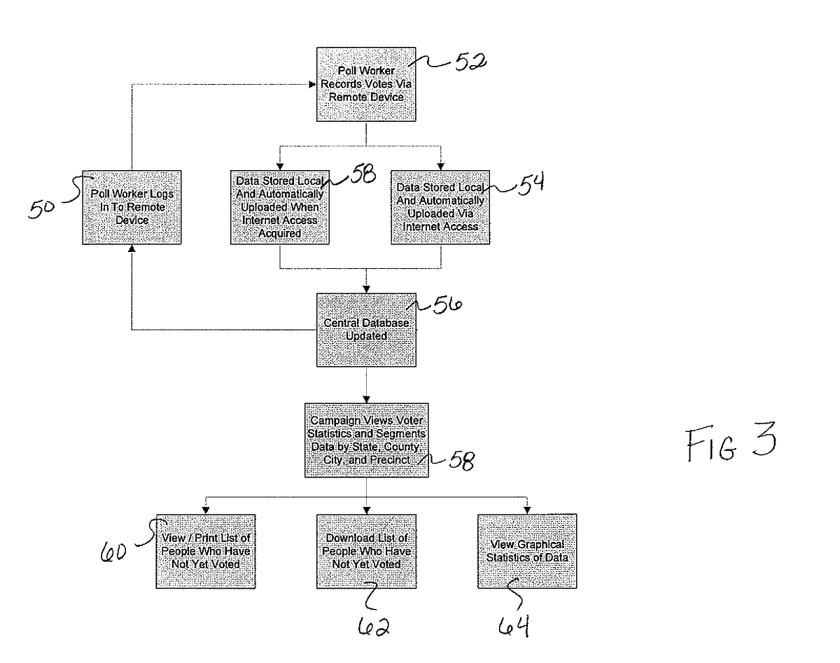

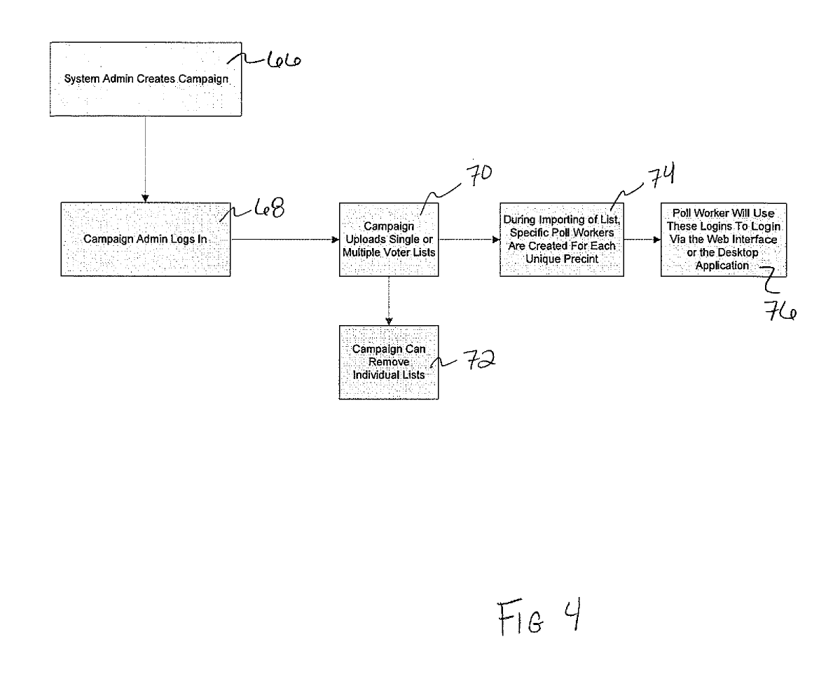

Referring now to FIG. 3, the overall steps involved in the use of the Application 12 begin with the user logging into the Application 12. In the case of a poll worker 16, the poll worker 16 logs in via an internet-enabled device such as a personal digital assistant 22 as shown in step 50. When a registered voter places a vote, the poll worker 16 records the vote in step 52. If the poll worker is connected to the database 24 via the internet 28 at the time, the recordation of the vote is stored locally on the poll worker's device in step 54 and the central database is automatically synced as shown in step 56. If, however, the poll worker 16 is not connected to the database 24 at the time of the vote recordation, the data is stored locally on the poll worker's device in step 58 and upon logging in again, the database 24 is synced with the data on the poll worker's device. Throughout election day, the campaign headquarters can access voting statistics and data as shown in step 58 and can perform many operations including viewing and/or printing a list of the voters who had not yet voted as shown in step 60, downloading and sending to other users a list of the voters who had not yet voted as shown in step 62, and view graphical statistics of voting data as shown in step 64.

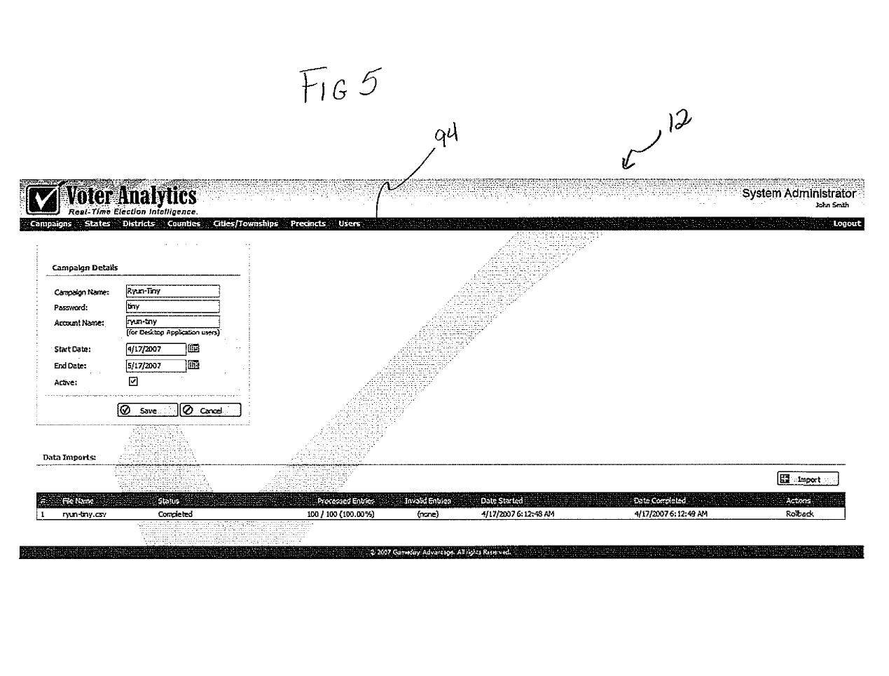

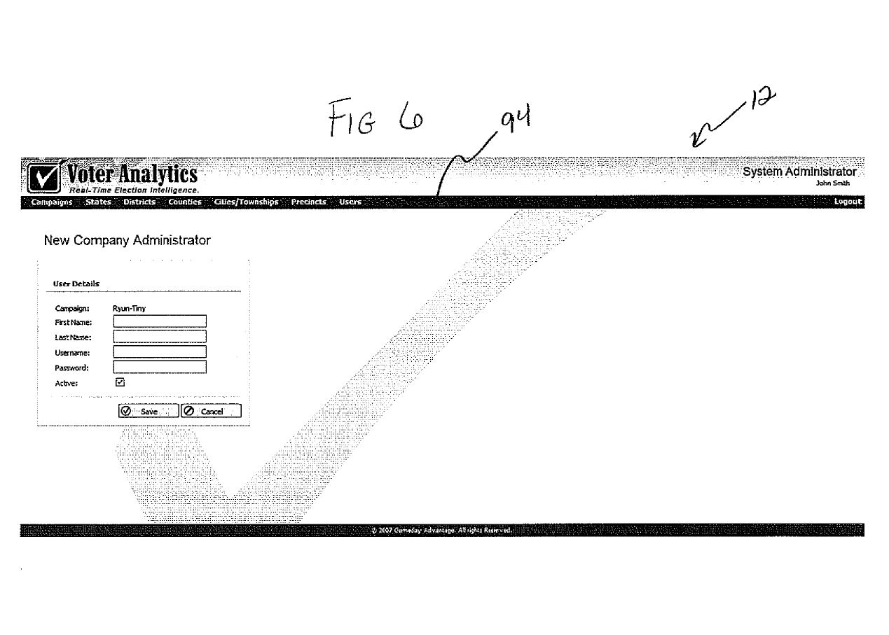

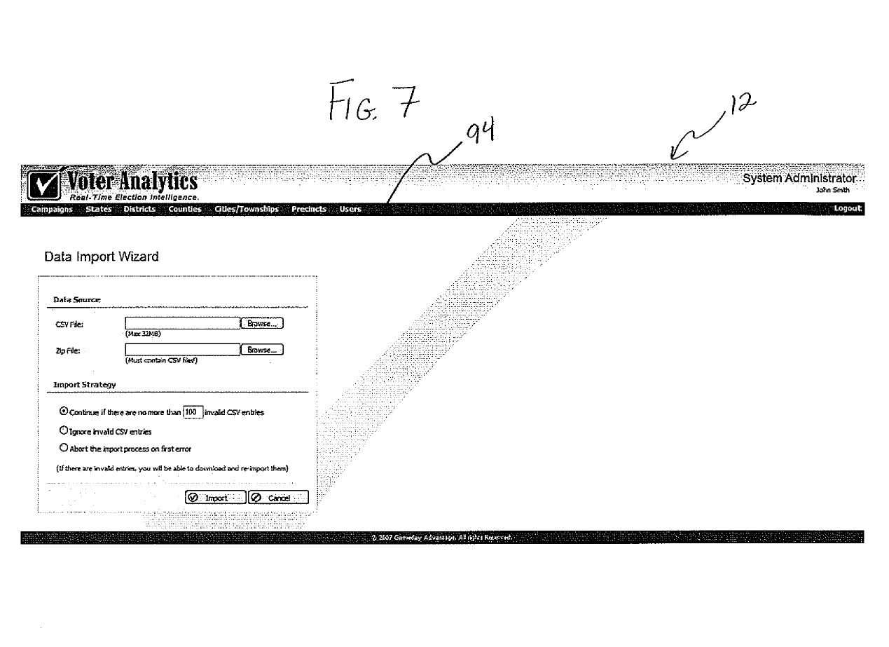

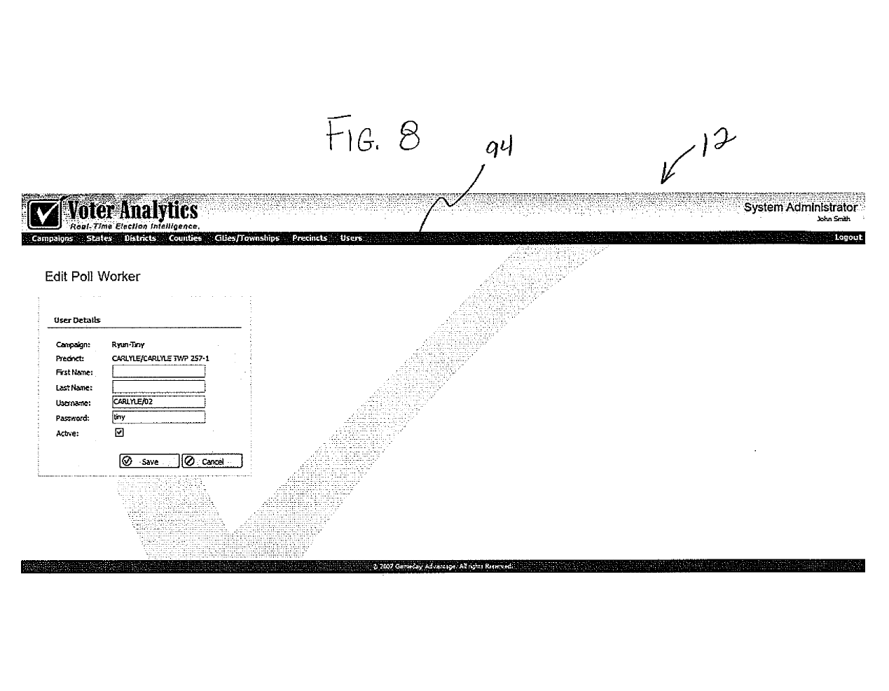

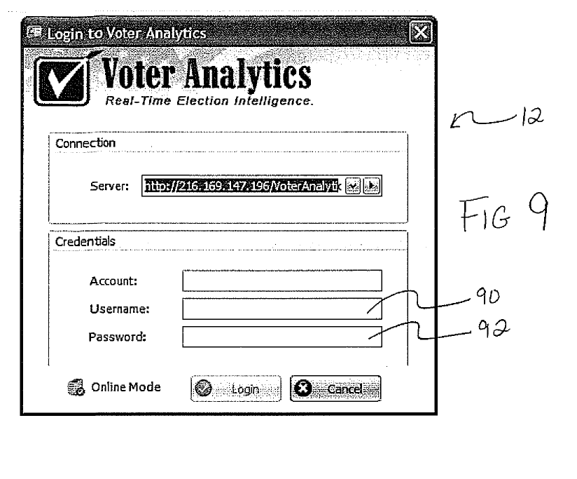

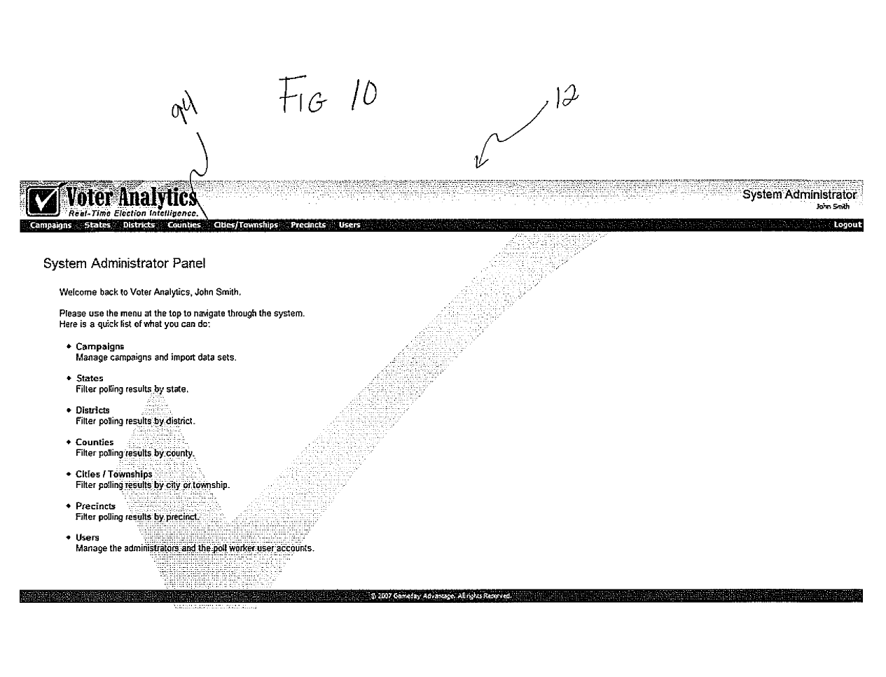

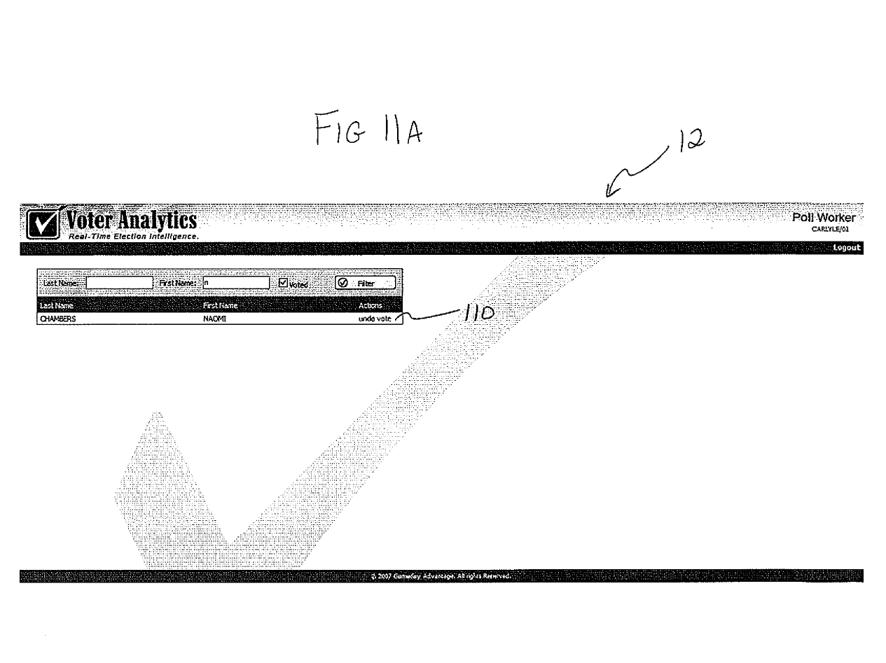

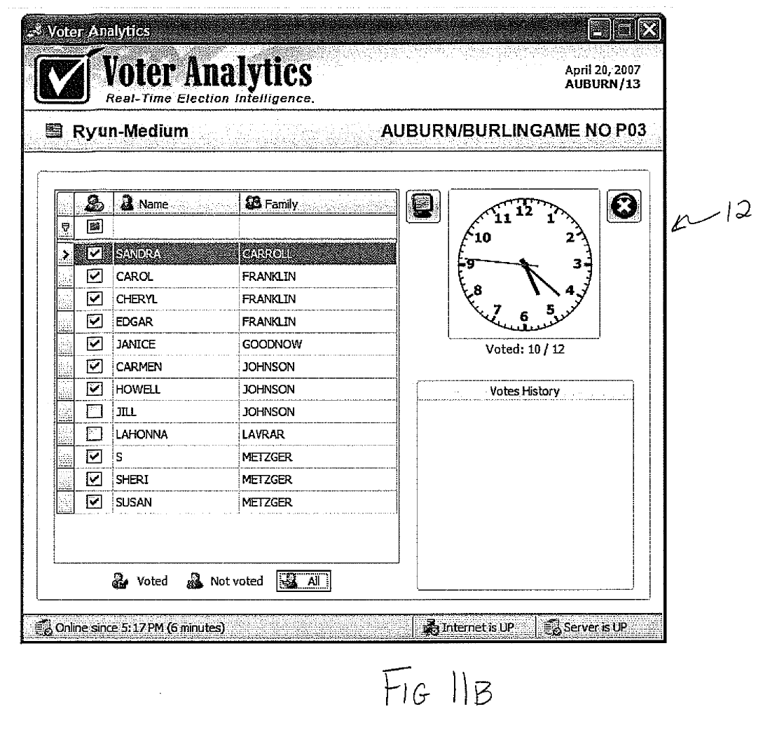

Referring now to FIG. 4, before the above process can take place, a campaign has to be created within the Application 12. As shown in step 66 and the screen shots in FIGS. 5 and 6, a system administrator creates a campaign and gives a campaign administrator access to the campaign data. Then, in step 68, the campaign administrator logs in and uploads voter lists (FIG. 7), as shown in step 70. Accordingly, the campaign administrator also has the ability to remove voter lists in step 72. The campaign administrator must then add poll workers (FIG. 8), creating login information for them, and may assign each poll worker to one or more precincts in step 74. As shown in step 76, the poll worker may then use the login information to connect to the database 24 at the Application 12 login screen such as the one shown in the screen shot in FIG. 9.

The method and system of the current invention will become even clearer with the further description of the functionality and features of the Application 12 contained hereinbelow. First, it is necessary to define and describe some of the main terms and features of the current invention such as user management and security, voter lists, races, voter tracking, statistics, phone and walk lists, and logs.

User Management & Security—Users are defined as those who will be accessing and using the Application 12 through a secure, web-based interface. While the number of different types of users that may exist in the Application 12 is limitless, a list of the types of users for the preferred embodiment of the current invention appears herein below. Users are entered into the Application 12 by other users having the proper permissions to create users. The Application 12 will collect and store data identifying users including such information as their name, address, email, phone number, etc. These users will also be assigned to races, districts, counties, cities and/or precincts that together with the Application's group-based security (explained below) will control the level of accessibility for each user.

Voter Lists—Voter lists are imported into the Application 12 database by users with the authority to do so. The voter lists may contain data such as, but not limited to, name, address, district (congressional and state), county, city, and precinct in which the voter lives. Once in the database, voter information for a particular voter may be edited by users with the appropriate permissions.

Races—Those users with proper permissions will be able to create and edit races. Races will be assigned districts (state and/or congressional) or counties which will allow users to view voter data associated with that race.

Voter Tracking—Users are able to search for individual voters in the voter list and record ballots being cast from various precinct locations. This data will then be used to generate phone and walk lists so field staff know where focus is needed.

Phone and Walk Lists—Phone and walk lists can be generated based on search criteria entered by the user. Phone and walk lists may include a variety of information such as voter name and phone number or address. The phone and walk list may also include information such as party affiliation.

Logs—Users of the Application 12 are able to view multiple logs, including phone and walk list logs. These logs will be used to evaluate voter data and be compared to charts and graphs. These logs can only be accessed by users with the proper security level. One skilled in the art will appreciate that the number of different logs that can be generated by the data contained in the database are numerous.

In view of the foregoing, a further description of the functionality of the instant invention now follows, specifically a description of the different pages of the Application 12 and the function(s) available on that page. One skilled in the art will appreciate that the description of the functionality, look, and feel of the Application 12, including the screen shots, are simply one embodiment of the preferred invention for illustrative purposes only; many variations of the functionality, look, and feel of the instant invention are possible without varying from the scope and spirit of the invention.

The application is preferably accessed via a secure, web-based interface and initially the user is presented with a log in screen such as shown by the screen shot in FIG. 9. Once logged in, users are able to navigate to multiple pages through the Application 12 similar to navigating a website. Of course, the availability of particular pages and/or functions will depend on the access level granted to the particular user. The pages listed and described below are those included in the preferred embodiment of the present invention, but a person skilled in the art will recognize that the page setup and the functions listed on particular pages or the functionality provided in general can vary without straying from the scope of the present invention.

Login Page—The login page (FIG. 9) preferably contains a text box for user name 90 and password 92 and a “forgot password” link (not shown). When this link is clicked they are taken to a page asking for their email address. The user enters their email address and clicks the “email me” button or a button or link with a similar message. When the email address is verified as a valid email address and an active user, a new temporary password will be emailed to that email address. Once the user logs into the system using this temporary password he/she will have the ability to change it to something they will remember.

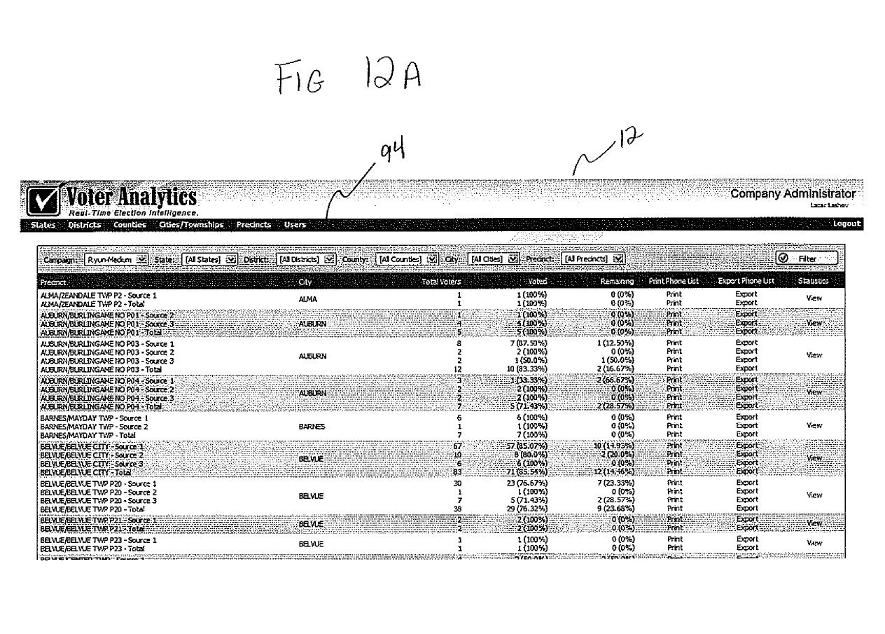

Main Menu Page—The main menu page (FIG. 10) contains links to navigate through the Application 12. These links may include but are not limited to voter, voter tracking, voter correction, user, races, districts, counties, cities, and precincts. The navigational links displayed to the user are based on the security level and/or the assignment of the user. For instance, and as described in more detail below, a poll worker will only see the voter tracking and voter correction links. The poll worker will not see the races, districts, counties or cities links.

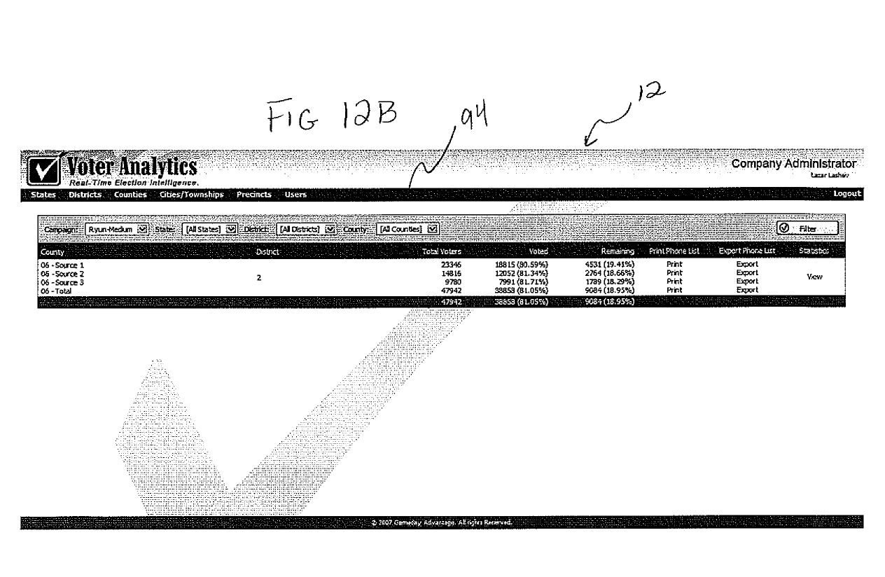

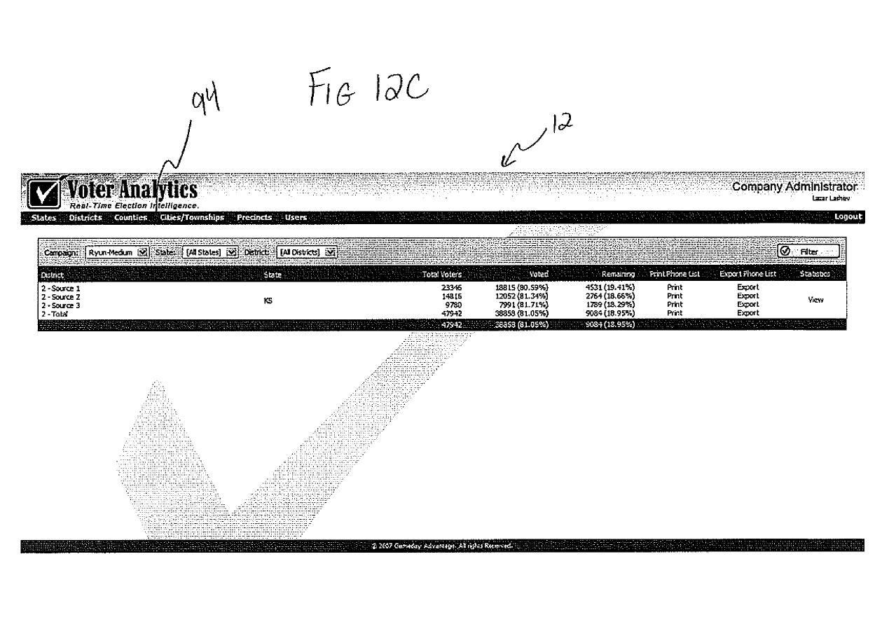

Voter Page—The voter page is used to search for voters in the system, as shown by FIGS. 1A and 11B. Search criteria includes, but not be limited to, name, party affiliation, precinct and voted (yes/no dropdown list or checkbox). A data grid 110 containing a list of names will be returned based on the search criteria. The names of the voters returned function as links to the voter detail page (described below) for that particular voter. The data grid may contain any combination of data about the voter, but preferably at least one column of the grid indicates whether or not the voter has voted in the current election.

Voter Detail Page—The voter detail page (not shown) includes information stored in the database about the voter such as name, address, phone number, districts, county, and precincts in which the voter lives. Preferably, these fields are visible to all users except the poll worker and are only editable by users with the proper security level.

User Page—The user page (not shown) is used to add, edit, and search for users in the system. A data grid preferably containing a list of voter names will be returned based on the search criteria. Search criteria may include, but is not limited to, race, district, county, precinct, user type, and name. The names of the users returned operate as links to the user detail page. Preferably, a column in the data grid will serve as a link to the user detail page. Additional columns can be included in the grid without straying from the scope of the present invention. For those users with the appropriate security rights, the user page also contains an “add” button to add users to the system.

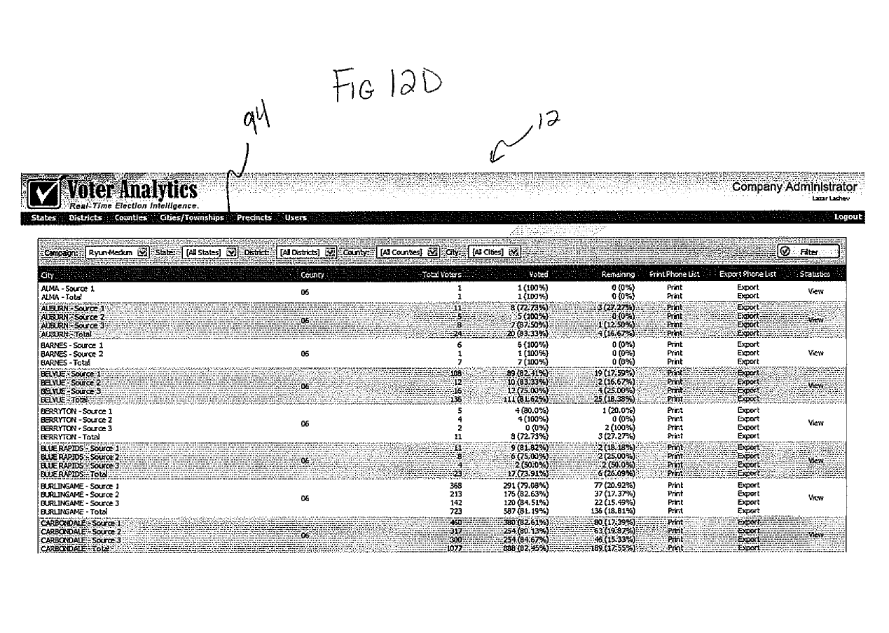

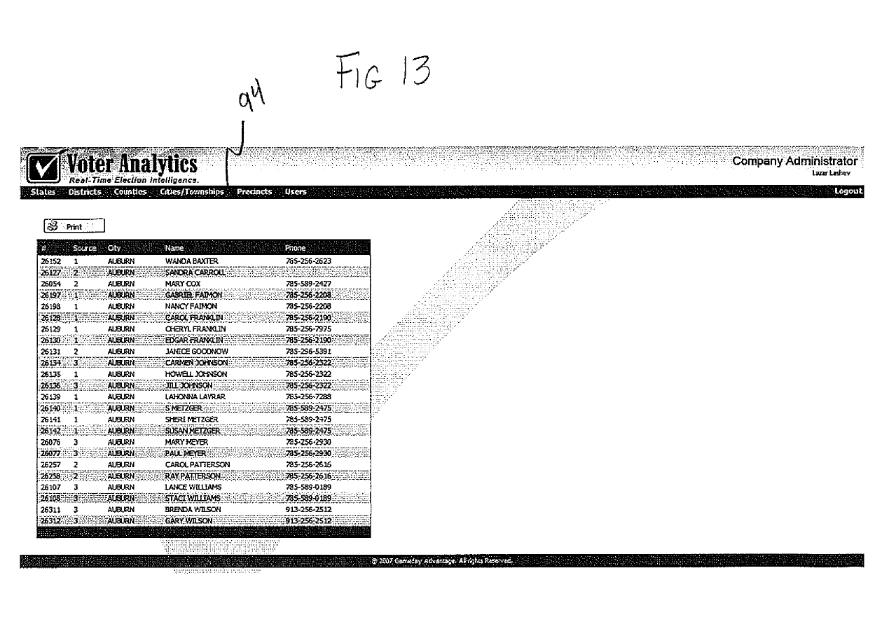

User Detail Page—The user detail page (not shown) includes any or all of the data stored in the database about the user such as name, address, type/security level, and the races, districts, counties, cities or precincts to which they have been or will be assigned. The purpose of assigning users to races is to segment district, county, city, and precinct data for particular races. The user types/security levels for the preferred embodiment of the current invention are as follows:
Read Only—In the current invention, a user with read only rights can log into the system and view only the district, county, city, and precinct pages the user has been assigned to in order to monitor voters. The user will still be able to view the statistics page for the assigned district, county, city and precinct.
Poll Worker—In the current invention, the poll worker can log into the system and view only the voters in the precincts to which the user has been assigned. The poll worker is able to record and delete votes from a precinct location. When a Poll Worker who is assigned to more than one precinct logs in, he/she will choose the precinct he/she is working in from a drop down list. This precinct will be saved as a hidden variable and be part of the search criteria when searching for voters in the voter tracking page.
Phone Bank Manager—According to the preferred embodiment of the current invention, once a phone bank manager logs into the system, he/she is able to only view voters in the areas that the user has been assigned to. The user can view the district, county, city, and precinct pages (FIGS. 12A-12D) in order to monitor voters. The user is also able to view the statistics page and is able to create phone (FIG. 13) and walk lists.
Field Staff—In the current invention, the field staff is able to log into the system and view only voters and the areas that the user has been assigned to. The user will view the district, county, city, and precinct pages in order to monitor voters. The field staff is also able to view the statistics page.
Lead Campaign Staff—According to the current invention, the lead campaign staff logs into the system and is able to view all voters related to the campaign. The lead campaign staff is able to enter all lower level security users for specific districts, counties, cities, and precincts into the system and can view the district, county, city, and precinct pages in order to monitor voters. The lead campaign staff will also be able to view the statistics page.
Administrator—The administrator logs into the system and is able to view all data in the Application 12.

User Assignment Page—The user assignment page (not shown) is used to assign users to regional areas. The user can be assigned to districts, counties, cities and precincts. Once a user has been assigned regional areas, all searches conducted by the user will be limited to the user's assigned regional areas. According to the preferred embodiment of the present invention, the poll worker is a special case; they will never need to be assigned to anything except a precinct. Of course, one skilled in the art will appreciate that this could be modified without straying from the scope of the present invention.

Race Page—This page can be accessed from the main menu or the menu bar 94 and contains search functionality to search for a political race in the database. Preferably, the possible search criteria are race type (congressional, state wide etc.), race name and/or state. A data grid will be returned from the search containing records that match the search criteria. A column in the data grid will be an “edit” link that will navigate to the race detail page. A second column in the data grid contains the name of the political race as a link. The link will navigate to the largest regional area associated with the race. A third column in the data grid is a link to the statistics page for the race. The race page will also contain an “add” button so users with the proper security level can add races to the system.

Race Detail Page—The race detail page (not shown) is preferably accessed from the race page. This page will contain information on the race including but not limited to name, type, state and date of the race. Users with the proper security level can edit the race detail fields.

Race Assignment Page—In the preferred embodiment of the current invention, the race assignment page (not shown) allows a user having the proper security rights to assign regional areas to a race. The user can assign districts, counties, cities and/or precincts to a race. Once a race has been assigned regional areas, all searches for this race will be limited to the assigned areas.

Regional Area Search Pages—In the preferred embodiment, the regional area search pages include the district, county, city and precinct pages (FIGS. 12A-12D). Search criteria is displayed on all of these pages allowing searches for the desired race, depending on a user's assignment and/or rights. Only search criteria for regions assigned to a race will be displayed on each of these pages and only search criteria for the regions assigned to the user will be displayed on each of these pages. For instance, a user is assigned to three cities in a race that has five counties assigned to that race. When the user accesses the city page, district and county will not be part of the search criteria because the user has not been assigned to a district or county. When the user accesses the city page they will see all three cities listed. They now can click on the desired city to get to all precincts located in that city. As another example for the same race, when a user with a higher security level and assigned to two counties in the race accesses the city page, they will see the county as search criteria. This is because they are assigned to multiple counties. Continuing with this example, district will not be search criteria for any user assigned to this race because there are no districts assigned to this race.

District Page—Preferably, the district page is accessible from the main menu or menu bar, and is a search page to search for districts in the database. The main search criterion is race and a search preferably returns a data grid of districts (FIG. 12C) based on the search criteria (race) entered. The district page is also accessible directly from the race page. When accessed from the race page, the district page's search criteria will automatically be set to that race and the district page will display a data grid of districts in that race.

One column in the data grid contains the name of the districts. Preferably, the name of the district is a link to the county page displaying all counties within that district. A second column in the data grid contains the total number of registered voters for that district. A third column in the data grid contains number of registered voters in the district that are affiliated with the Republican Party while a fourth column contains the number of registered voters in the district that are affiliated with the Democratic Party. Yet another column in the data grid contains the number of registered voters not affiliated with the Republican Party or the Democratic Party in that district. A sixth column in the data grid contains the percentage of Republicans yet to vote for that district. A seventh column in the data grid contains the percentage of Democrats yet to vote for that district. An eighth column in the data grid contains the percentage of other affiliated voters yet to vote for that district. Yet another column in the data grid contains a link to the statistics page for that individual district.

According to the preferred embodiment of the invention, the three types of districts that may be assigned to a race or a use are U.S. Congressional, State House and State Senate Districts. The user can specify the type of district to be assigned in the race assignment page.

County Page—The county page, when accessed from the main menu or menu bar, is a search page to search for counties in the database. Search criteria are race and district. A search will return a data grid of counties based on the search criteria entered. Only the search criteria associated with the race and user assignment/security level will be displayed.

The county page can also be accessed directly from the district page. When accessed from the district page, the county page's search criteria is automatically set to that district and the county page will display a data grid of counties in that district. Preferably, one column in the data grid contains the name of the county. The name of the county is a link that to a page listing all cities within that county. A second column in the data grid contains the total number of registered voters for that county. A third column in the data grid contains the number of voters affiliated with the Republican Party for that county. A fourth column in the data grid contains the number of voters affiliated with the Democratic Party for that county. A fifth column in the data grid contains the number of other voters that are not affiliated with either the Republican or Democratic Parties for that county. A sixth column in the data grid contains the percentage of Republicans yet to vote for that county while a seventh column in the data grid contains the percentage of Democrats yet to vote for that county. An eighth column in the data grid contains the percentage of other voters that have yet to vote for that county. Yet another column in the data grid is a link to the statistics page that displays statistics for that individual county.

City Page—The city page, when accessed from the main menu or menu bar, is a search page to search for cities in the database. Search criteria are preferably race, district, and county. A search will return a data grid of cities based on the search criteria entered.

This city page can also be accessed directly from the county page. When accessed from the county page, the city page's search criteria will automatically be set to that county and this city page will display a data grid of cities in that county. Preferably, one column in the data grid contains the name of the cities. The name of the city is a link that to a page listing all precincts within that city. A second column in the data grid contains the total number of registered voters for that city. A third column in the data grid contains the number of voters affiliated with the Republican Party for that city. A fourth column in the data grid contains the number of voters affiliated with the Democratic Party for that city. A fifth column in the data grid contains the number of other voters that are not affiliated with either the Republican or Democratic Parties for that city. A sixth column in the data grid contains the percentage of Republicans yet to vote for that city while a seventh column in the data grid contains the percentage of Democrats yet to vote for that city. An eighth column in the data grid contains the percentage of other voters that have yet to vote for that city. Yet another column in the data grid is a link to the statistics page that displays statistics for that individual city.

Precinct Page—When the precinct page is accessed from the main menu or the menu bar 94 the page is a search page to search for precincts in the database. The search criteria are race, district, county and city and precinct. The search will return a data grid of precincts based on the search criteria entered. The precinct page can be also accessed directly from the city page. When accessed from the city page, the precinct page's search criteria will automatically be set to that city and the precinct page will display a data grid of precincts in that city.

Preferably, one column in the data grid contains the name of the precinct. The name of the precinct is a link that to a page listing all registered voters within that precinct. A second column in the data grid contains the total number of registered voters for that precinct. A third column in the data grid contains the number of voters affiliated with the Republican Party for that precinct. A fourth column in the data grid contains the number of voters affiliated with the Democratic Party for that precinct. A fifth column in the data grid contains the number of other voters that are not affiliated with either the Republican or Democratic Parties for that precinct. A sixth column in the data grid contains the percentage of Republicans yet to vote for that precinct while a seventh column in the data grid contains the percentage of Democrats yet to vote for that precinct. An eighth column in the data grid contains the percentage of other voters that have yet to vote for that precinct. Yet another column in the data grid is a link to the statistics page that displays statistics for that individual precinct.

Voter Tracking Page—A voter tracking page (not shown) is accessible from the main menu or the menu bar. Preferably, when a poll worker logs into the system, only the voter tracking page and the vote correction page are accessible.

The voter tracking page allows a user to search for voters that have not voted in the precinct assigned to the user. The search returns a data grid of voters based on the search criteria. Preferably, one column of the data grid will be a checkbox that is used to indicate whether the voter has voted. Once the checkbox is checked by the poll worker or any other authorized user, the page will automatically post back to the database and save the vote in the database. Preferably, the date, time and identity of the user recording the vote will be also recorded. After a vote has been saved, the voter tracking page will immediately be ready to search the next voter in the system. There will also be a link on this page to undo the last vote saved in the system. The undo link will preferably include the name of the voter. This undo option will cut down on the need to navigate to the vote correction page.

Preferably, this page will not contain any graphics which will decrease the time it takes for the page to load on the poll worker's portable device.

Vote Correction Page—The vote correction page (not shown) can be accessed from the main menu or the menu bar. Preferably, the vote correction page is a search page to search for voters that have voted in the precinct assigned to the user logged in. The search will return a data grid of voters based on the search criteria. Preferably, one column of the data grid will be a checked checkbox. This checkbox can be unchecked by the user to indicate that voter has not voted. Once the checkbox is unchecked a message will pop up asking the user if they are sure they want to remove the vote. This pop up message will also include the name of the voter so it is clear to the user who they are correcting. Once the user clicks ok to the message the page will automatically post back to the server and remove the vote in the system. Preferably, the date, time and identity of the user changing the voting status will be saved to record the fact that the vote was deleted from the system.

This page preferably does not contain any graphics in order to decrease the time it takes for the page to load on the poll worker's portable device.

Statistics Page—The statistics page (FIG. 12) can be accessed from the race, district, county, city or precinct pages. The statistics page shows statistics based on which page it was accessed from. There will be numeric statistical data, graphs and maps. The types of graphs may include line graphs 96, pie charts 98, and bar charts 100. The graphs may include the following: percentage of people voted over time, percentage of republicans or democrats voted and percentage of overall votes.

Phone and Walk List Generation Page—A user with the proper security level will be able to enter search criteria to generate the type of list desired. The phone list (FIG. 13) will preferably return a list of names, phone numbers and party affiliation for voters who have not voted for the desired regional area. The walk list (not shown) will return a list of names and addresses for voters who have not voted for the desired regional area. The walk list can be further organized by city, street and street number and mapping software will be used to generate walk lists. The results of the lists will be displayed in text format and can be sent to others users such as field workers. The lists can also be available in an Excel document if desired

Log Page—The log page (not shown) preferably contains links to multiple logs that can be viewed by the user. The user will use search criteria to search for the regional area and type of log to view. The walk list and phone list logs will contain the date and time of list generation, number of voters on the list and the regional area for which the list was created. The voter log will also contain the voter name, precinct, time voted and the user who saved the data into the system.

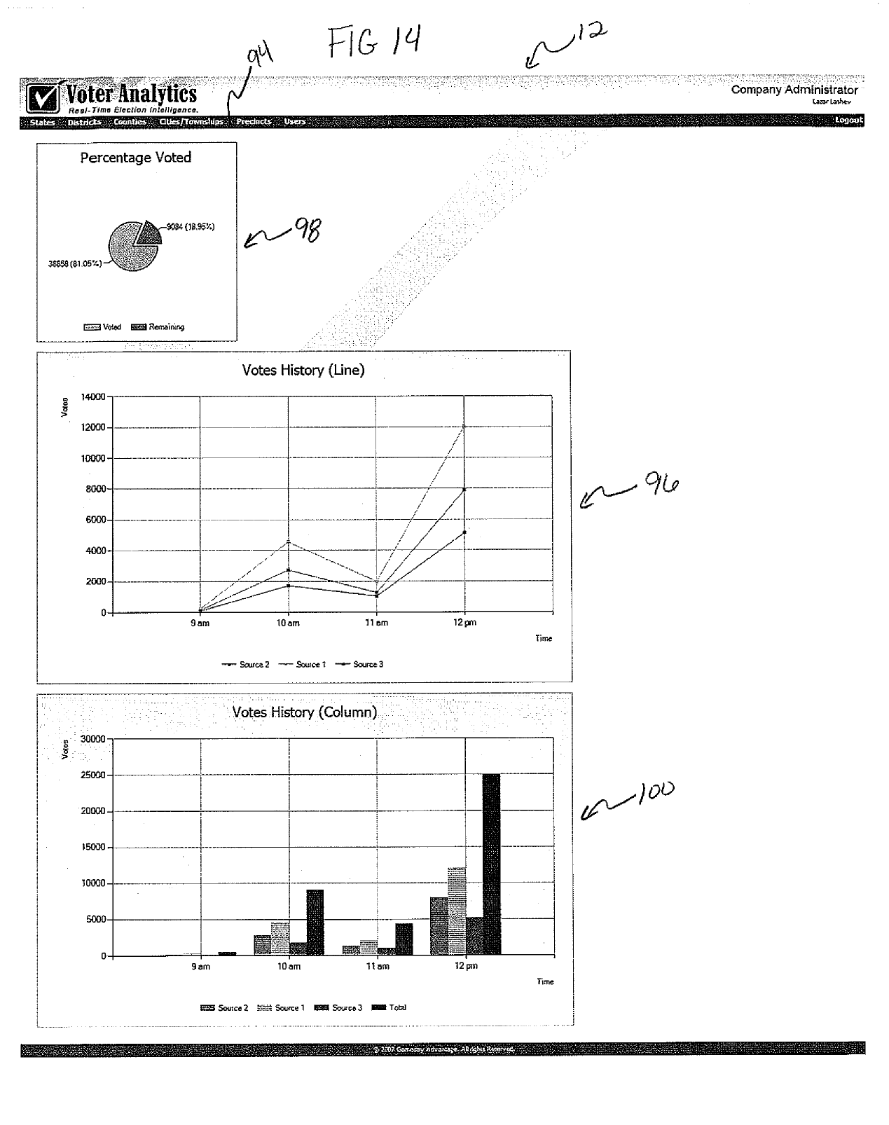

The screen shots provided in FIGS. 5-14 are for illustration only in order to provide examples of how the preferred embodiment of the current invention may be embodied. A screen shot for every screen of the Application 12 was not provided and further, the screen shots may not show every feature described herein. In such cases, the screen shots shall not be used to limit the scope of the present invention, but instead to show that many modifications are possible without straying from the spirit of the invention.

In accordance with the provisions of the patent statutes, the present invention has been described in what is considered to represent its preferred embodiment. However, it should be noted that the invention can be practiced otherwise than as specifically illustrated and described without departing from its spirit or scope. The functionality, look and feel of the Application 12 can vary greatly while still carrying out the underlying and main objective of the present invention. For example, additional functions and data may be stored in the database such as recording voters who requested an absentee ballot, tracking registered voters who need a ride to the polling location, and recording voters who requested campaign signs, etc.

What is claimed is:

1. An election day voter tracking system comprising:
a database server;
a web server;
a voter database for a campaign;
a voter tracking software application;
an internet connection;
at least one internet enabled portable device,
wherein said web server runs said voter tracking software application and is connected to said database server; and
wherein said voter database resides on said database server and is accessible by said at least one internet enabled portable device via said internet connection and said voter tracking software application.

2. An election day voter tracking system as claimed in claim 1 wherein said at least one internet enabled portable device can edit said voter database.

3. An election day voter tracking system as claimed in claim 1 wherein said at least one internet enabled portable device can edit said voter database in real time.

4. An election day voter tracking system as claimed in claim 1 wherein said voter tracking software application uses said voter database to generate a call list.

5. An election day voter tracking system as claimed in claim 1 wherein said voter tracking software application uses said voter database to generate a walk list.

6. An election day voter tracking system as claimed in claim 1 wherein said system comprises at least two voter databases and at least two campaigns wherein first of said at least two voter databases corresponds to first of said at least two campaigns and second of said at least two voter databases corresponds to second of said at least two campaigns.

7. An election day voter tracking system as claimed in claim 6 wherein one of said at least two voter databases is accessible by at least two of said at least two campaigns.

8. An election day voter tracking system as claimed in claim 6 wherein said system comprises at least two internet enabled portable devices.

9. An election day voter tracking system as claimed in claim 8 wherein first of said at least two voter databases is accessible by first of said at least two internet enabled portable devices and second of said at least two voter databases is accessible by second of said at least two internet enabled portable devices.

10. An election day voter tracking system as claimed in claim 8 wherein at least two of said at least two voter databases are accessible by at least one of said at least two internet enabled portable devices.

11. An election day voter tracking system as claimed in claim 1 further comprising a campaign computer connecting to said voter database using said voter tracking software.

12. An election day voter tracking system as claimed in claim 11 wherein said campaign computer sends information to said at least one internet enabled portable device.

13. A method of facilitating election day campaign efforts, comprising the steps of:
uploading at least one voter data file to a server;
downloading at least a portion of said at least one voter data file on the server to a portable device used by a poll worker;
editing of the at least one voter data file using the portable device;
manipulating data of the at least one voter data file by campaign headquarters;
creating a specialized voter list from the at least one voter data file by campaign headquarters;
sending said specialized voter list to a portable device used by a field worker; and
using said specialized voter list to contact voters.

14. The method as claimed in claim 13 wherein the step of editing of the at least one voter data file using the portable device further includes the steps of:
recording that a voter in one of the at least one voter data file has voted;
saving changes to the at least one voter data file on said portable device; and
sending changes to the at least one voter data file to the server.

15. The method as claimed in claim 14 wherein sending the changes to the server occurs in real time.

16. The method as claimed in claim 14 wherein sending the changes to the server occurs at a predetermined schedule.

17. The method as claimed in claim 14 wherein sending the changes to the server occurs upon a request by campaign headquarters.

18. The method as claimed in claim 13 further comprising the steps of:
creating at least one race;
assigning the at least one voter data file to at least one of the at least one race;
creating at least one user for each of the at least one race;
assigning security rights to the at least one user.

19. A method of generating a targeted voter report, comprising the steps of:
generating voter data representing a registered voter has voted at a polling place;
updating a database of all registered voters associated with the polling with the voter data;
creating a targeted voter report from the database listing all of the registered voters who have not yet voted; and
sending the report to a field worker for contacting the registered voters who have not yet voted.

20. A system for increasing voter participation comprising:
a database containing registered voter information and user information;
at least one campaign user associated with a political election in which the registered voters are eligible to vote;
at least one poll watcher portable device updating a list of registered voters assigned to a polling place and for generating data when one of the registered voters votes at the polling place; at least one field worker device for receiving a report of the ones of the registered voters who have not voted at the polling place; and a central control in communication with the at least one campaign, the at least one pole watcher portable device and the at least one field worker device for receiving the data generated by the at least one pole watcher portable device, updating the registered information and generating the report.
